(19) United States
(12) Patent Application Publication
(10) Pub. No.: US 2016/0123728 A1
(43) Pub. Date: May 5, 2016

(54) METHOD FOR CLASSIFYING HUMAN MOBILITY STATE USING PARTICLE FILTER

(71) Applicants: Ha Yoon SONG, Seoul (KR); Hongik University Industry-Academia Cooperation Foundation, Seoul (KR)

(72) Inventor: Ha Yoon Song, Seoul (KR)

(21) Appl. No.: 14/931,914

(22) Filed: Nov. 4, 2015

(30) Foreign Application Priority Data
Nov. 4, 2014 (KR) 10-2014-0152339
Mar. 11, 2015 (KR) 10-2015-0033575
Jun. 11, 2015 (KR) 10-2015-0082874

(51) Int. Cl. G01B 21/00; G01P 3/00

(52) U.S. Cl. CPC G01B 21/00; G01P 3/00

(57) ABSTRACT

Provided is a method of determining a mobility state of a specific target. The method of determining a mobility state of a specific target by using a particle filter having particles defined as N independent random variables, the method comprising: calculating a current speed of the specific target, and calculating a value relating to a cumulative probability at which the specific target has the current speed, repeating a particle update process of updating a value of each particle by a number of times according to a predetermined rule, and calculating an average value of values that the N particles updated have, and determining a mobility state of the specific target based on the average value, wherein a weigh is calculated to use for updating the value of the particle by using the cumulative probability.

### CROSS-REFERENCE TO RELATED APPLICATION

This application claims priority to Korean Patent Application No. 10-2014-0152339 filed on Nov. 4, 2014, Korean Patent Application No. 10-2015-0033575 filed on Mar. 11, 2015, and Korean Patent Application No. 10-2015-0082874 filed on Jun. 11, 2015, and all the benefits accruing therefrom under 35 U.S.C. §119, the contents of which are incorporated by reference in their entirety.

### BACKGROUND

The present disclosure relates to a method for classifying a human mobility state using a particle filter that is used in the field of information processing, and a device therefore.

It is possible to easily obtained GPS data on a smart phone user by using various applications due to the proliferation of a smart phone, so a lot of GPS data has been generated. In addition, a technology that determines the position of a human or object by using various technologies has been provided, so a lot of positioning data may be generated. Thus, there is a need for data analysis in various fields.

If it is possible to recognize the mobility state of a human only with position and time information obtained by using a smart phone or a portable GPS collection device, a derived result could be used in various application fields. For example, if it is applied to an exercise related application, it would be possible to more accurately calculate calories by checking the current state of a user in real time without calculating the calories consumed for exercise by using an average speed when the user jogs. Also, if a user repetitively stops at a specific position on the move, it is possible to guess only with the positioning data that there is a crosswalk at that position. If types of states are set as two states, ‘stop (or stable or stay)’ and ‘mobile’, it would be possible to express the states of all humans with two states. Thus, the present disclosure is focused on determining a human mobility state.

Positioning data collected by using a positioning data collection device may include errors for various reasons. Thus, the positioning data including the errors should be filtered or classified. That is, the step of classifying mobility states should be performed before the usage of the positioning data. The type classification may not be performed deterministically but may be performed stochastically.

In order to classify the human mobility state, the present disclosure uses simplest classification that has only two states, ‘mobile’ and ‘stable or stay’. The type classification would increase accuracy that an application program relating to the positioning data requires. Next, the classification of a speed value leads to the classification of transportation.

The determination of the human mobility state has been used in the intermediate process of a study on the effect of weather on a human's pattern, and such a study is presented in Paper 1:

### [Paper 1]

Horanont T, Phithakkitnukoon S, Leong T W, Sekmoto Y, Shibasaki R (2013) Weather Effects on the Patterns of People's Everyday Activities: A Study Using GPS Traces of Mobile Phone Users. PLos ONE 8(12): e81153.doi:10.1371/journal.pone.0081153.

In the study above, mobile and stay states are classified by using sets of m pieces of positioning information on a continuous time that contain latitude, longitude and time information. It is determined to be stay when a distance to a pair of sequences among all different pieces positioning information in the sets is smaller than or equal to a specific limit value, and it is determined to be mobile when the distance is equal to or larger than the specific limit value.

In order to perform the above-described classification, the present disclosure uses a technique used in so-called ‘particle filter’ based on positioning data collected with a GPS, etc.

The particle filter is called a Sequential Monte Carlo method and is based on Bayesian statistics. The particle filter is used for parameter estimation and state estimation. The fundamental concept of the particle filter is to generate and use a plurality of independent random variables. The independent random variables are called particles. The initial values of the particles are set via initialization from a state space. Also, the values of the particles are updated by using weights, newly input observation values as inputs. Theory on the particle filter is also presented in Paper 2 below:

### [Paper 2]

Chen, Zhe “Bayesian filtering: From Kalman filters to particle filters. and beyond” Technical report, McMaster University, 2003.

The algorithms of the particle filter include sampling importance resampling (SIR) and sequential importance sampling (SIS), the biggest difference of which is whether there is a resampling process. In the present disclosure, the algorithm having no resampling process is used.

The operation sequence of the SIS algorithm of the particle filter is as follows. Firstly, generated particles X are appropriately initialized. Secondly, a new measurement value Z is input and a likelihood probability P (Z|X) is updated. Thirdly, the values of the particles X are updated by using a weight W obtained by using the likelihood probability. Lastly, the second and third processes are repeated through condition setting.

The fact that the particle filter may be currently used for the position estimation of a robot in the robot field is presented in Paper 3 below:

### [Paper 3]

S. Thrun “Particle Filters in Robotics” Proceeding UAI'02 Proceedings of the Eighteenth conference on Uncertainty in artificial intelligence, Pages 511-518, 2002.

Also, the fact that it is possible to use the particle filter for the position estimation of a human by using a WiFi signal in computer engineering is presented in Paper 4 below:

### [Paper 4]

### CHOI-Eunmi, OH-Whikyung, and KIM-Inchul, “Particle Filters for Positioning WiFi Device Users”, Journal of KIISE, Software and Application, Vol. 35, No. 5, 2012.

### SUMMARY

The present disclosure provides a method for analyzing positioning data, in which a technology using a particle filter and a technology linking a parameter relating to positioning data to the particle filter are provided.

In accordance with an exemplary embodiment, a method of determining a mobility state of a specific target by using a particle filter having particles defined as N independent random variables includes calculating a current speed of the specific target, and calculating a value relating to a cumulative probability at which the specific target has the current speed, repeating a particle update process of updating a value of each particle by a number of times according to a predetermined rule, and calculating an average value of values that the N particles updated have, and determining a mobility state of the specific target based on the average value, wherein a weigh is calculated to use for updating the value of the particle by using the cumulative probability.

The particle update process may include subtracting the value relating to the cumulative probability from the value of each particle to calculate the weight, and subtracting the weight from the value of each particle or adding the weight to the value of each particle to update the value of each particle.

The current speed may be a time weighted-speed T at a first time obtained by multiplying one or more speed values detected at and before the first time for the specific target by predetermined weights, respectively and adding values obtained through the multiplication, the speed value detected at the first time for the specific target, or an average value of the one or more speed values detected at and before the first time for the specific target.

The multiplied weight may increase as a time is closer to the first time.

The mobility state may be divided into a plurality of states including a stay state and a mobile state, and determining to which a state belongs among the plurality of states may be performed by comparing, an average value of values that the N particles have, with one or more predetermined critical values.

In accordance with another exemplary embodiment, a mobility state determination method includes initializing a particle filter that has, as particles, N independent random variables having a value of 0 to 1, repeating a particle update process by a number of times according to a predetermined rule, and calculating an average value of the N particles updated, and determining a mobility state of the specific target by using the average value, wherein a current speed provided at a first time for the specific target is used as a new observation value for inputting to the particle filter.

The particle update process may include obtaining the current speed, updating a likelihood probability at which the specific target has the current speed, based on current values that the N particles have, obtaining a weight by using the updated likelihood probability, and updating the particle by using the weight.

The updating of the particle may include updating the value of the particle to 0 when the value may become a negative value.

The likelihood probability may be found by using a cumulative distribution function of exponential distribution.

The current speed may be the speed value detected at the first time for the specific target, an average value of one or more speed values detected at and before the first time for the specific target, or a time weighted-speed T at the first time obtained by multiplying the one or more speed values detected at and before the first time for the specific target by predetermined weights, respectively and adding values obtained through the multiplication.

The mobility state may be divided into a plurality of states including a stay state and mobile states according to one or more transports, the mobile states according to the one or more transports may include a mobile state by walking and a mobile state by a vehicle, and determining to which a state belongs among the plurality of states may be performed by comparing, an average value of the N particles updated, with one or more predetermined critical values.

In accordance with yet another exemplary embodiment, a mobility state determination device includes a processing unit that determines a mobility state of a specific target by using a particle filter having particles defined as N independent random variables, wherein the processing unit is configured to calculate a current speed of the specific target, and calculate a value relating to a cumulative probability at which the specific target has the current speed, repeat a particle update process of updating each particle by a number of times according to a predetermined rule, and calculate an average value of values that the N particles updated have, and determine a mobility state of the specific target based on the average value, wherein a weight is calculated to use for updating the value of the particle by using the cumulative probability.

### BRIEF DESCRIPTION OF THE DRAWINGS

Exemplary embodiments can be understood in more detail from the following description taken in conjunction with the accompanying drawings, in which:

FIG. 1 is a flowchart of a mobility state determination method according to a first embodiment of the present disclosure;

FIG. 2 is a graph of an a value according to the number of positioning information according to a second embodiment of the present disclosure;

FIG. 3A is a diagram representing position information on vehicle mobility on a map according to the second embodiment of the present disclosure;

FIG. 3B is a speed-probability graph for vehicle's position information according to the second embodiment of the present disclosure;

FIG. 4A is a diagram representing position information staying at an express way rest area on a map according to the second embodiment of the present disclosure;

FIG. 4B is a speed-probability graph for position information staying at the express way rest area according to the second embodiment of the present disclosure;

FIG. 5A is a diagram representing position information on vehicle mobility on a map according to the second embodiment of the present disclosure;

FIG. 5B is a speed-probability graph for position information on vehicle mobility according to the second embodiment of the present disclosure;

FIG. 6 shows stay and mobile states on a map by using a kml viewer;

FIG. 7 divides, data on a section enabling easy movement without traffic jam, into mobile and stay states;

FIGS. 8 and 9 are graphs of a speed upon stay and mobile at a specific time and a probability value obtained from a particle filter in the entire data in FIG. 7.

FIG. 10 is a flowchart of a determination method of mobility using a computer according to an embodiment of the present disclosure;

FIG. 11A is a diagram representing position information on vehicle mobility on a map according to a fourth embodiment of the present disclosure;

FIG. 11B is a speed-probability graph for vehicle's position information according to the fourth embodiment of the present disclosure;

FIG. 12A is a diagram representing position information on vehicle mobility according to a fifth embodiment of the present disclosure; and

FIG. 12B is a speed-probability graph for vehicle's position information according to the fifth embodiment of the present disclosure.

### DETAILED DESCRIPTION OF EMBODIMENTS

In the following, embodiments of the present disclosure are described with reference to the accompanying drawings. However, the present disclosure is not limited to the embodiments described in the specification and may be implemented in other forms. The terms used herein are to help the understanding of the embodiments and are not intended to define the scope of the present disclosure. Also, singular forms used below also include plural forms unless stated to the contrary.

### First Embodiment

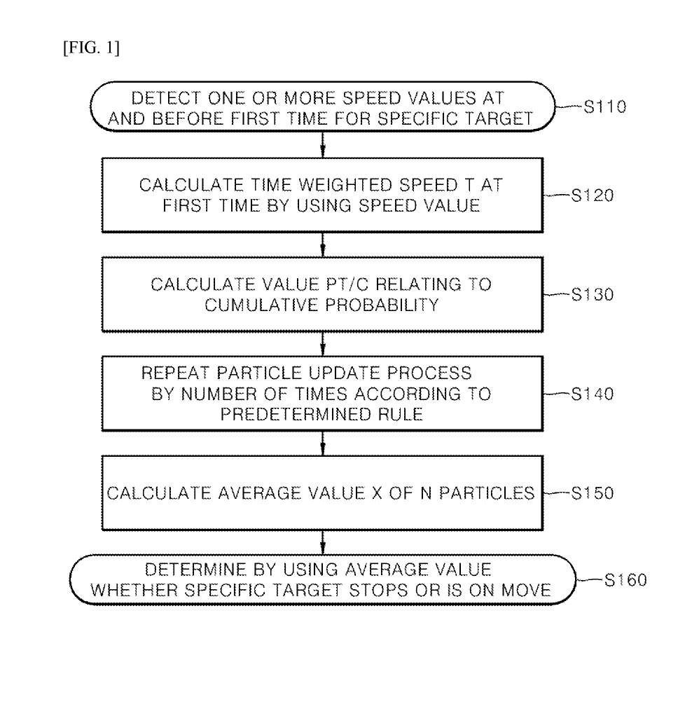

FIG. 1 is a flowchart of a mobility state determination method according to a first embodiment of the present disclosure.

In the embodiment, it is possible to determine the mobility state of a specific object by using a particle filter that has N independent random variables Particle[k] as particles. In this case, k is an integer between 0 and N−1. Each particle is configured to have a value of 0 to 1. A value that each particle has may be a probability.

The mobility state determination method may receive one or more speed values detected at and before a first time with respect to the specific object in step S110.

In addition, in step S120, it is possible to calculate a time weighted-speed T at the first time by using the one or more speed values detected at and before the first time.

In addition, in step S130, it is possible to calculate a value for a cumulative probability Pt/C that the specific object may have the time weighted-speed T.

In addition, in step S140, it is possible to repeat a particle update process of updating each particle by the number of times according to a predetermined rule. In this case, the particle update process may include subtracting the value for the cumulative probability Pt/C from the value of each particle to calculate a weight W in step S141, and subtracting the weight W from the value of each particle to update the value of each particle in step S142.

In addition, in step S150, it is possible to calculate the average value X of the N particles that have been updated.

In addition, in step S160, it is possible to determine by using the average value X whether the specific object has stopped or is on the move.

### Second Embodiment

A positioning data error leads to a speed value error and thus to a mobility state error. Thus, the second embodiment of the present disclosure may use past speed values. The past speed values have a weighted value every time stamp. The more recent the speed value is, the greater the effect may be.

In order to make a speed value window, it is possible to refer to the number of speed value samples included in the window as a window size. Thus, the window size may have any natural number value. In the present embodiment, the window size is set to 5. That is, Equation 1 below is for the present embodiment and it may be seen that five time stamps are used.

In the present embodiment, so-called time weighted speed T generated by using Equation below is used.

T=(1−α)Vₜ+α((1−α)Vₜ₋₁+α((1−α)Vₜ₋₂+α((1−α)Vₜ₋₃+α(Vₜ₋₄)))) [Equation 1]

T denotes the weighted average of time weighted speeds. The symbol a presented in Equation 1 denotes a rate that determines a weight for a speed value at each time stamp. The symbol a may have a value of 0 to 1. In Equation 1, a total of five speed values are used. T may be derived by using one current speed value and four past speed values. In the algorithm used in the present embodiment, the particle filter may use the above-described T as the weight of particles. In the present disclosure, the ‘time weighted speed T’ may be referred to as the term ‘time weighted-speed T’.

In Equation 1, if the current time is t, the current speed is Vₜ and four past speeds are Vₜ₋₁, Vₜ₋₂, Vₜ₋₃, and Vₜ₋₄. Vₜ₋₁ is a speed closer to the current speed in comparison to Vₜ₋₄. If α is set to 0.0, only the current speed is used in Equation 1. If α is set to 1.0, only the past speed value Vₜ₋₄ is used in Equation 1

Algorithm 1 presented below is an algorithm for mobility state classification using the particle filter used in the present embodiment.

[Algorithm 1]

| 01: procedure PARTICLEFILTER(N, Vₜ₋₁, Vₜ₋₂, Vₜ₋₃, Vₜ₋₄) | |
|---|---|
| 02: Calculate Vₜ | |
| 03: // Calculate current speed by harversine formula | |
| 04: Calculate T | |
| 05: // Calculate Time-Weighted Speeds by equation (1) | |
| 06: Particle[N] // Declare and Initialize Particles | |
| 07: while condition do | |
| 08: for k=0 to N−1 do | |
| 09: W = f(Particle[k], T); //weight update | |
| 10: If conditions then | |
| 11: Particle[k] = Particle[k] − W | |
| 12: Else | |
| 13: Particle[k] = Particle[k] + W | |
| 14: endif | |
| 15: | //particle update |
| 16: end for | |
| 17: end while | |
| 18: X = Average(Particle[N ]) //calculate X, return X | |
| 19: return X | |
| 20: | // Mobility State Classification |

21: end procedure

Algorithm 1 uses the fundamental algorithm of the particle filter and includes particle generation and initialization (in line 6), weight update and particle update (in lines 7 to 16, repetition (while—end while), and mobility state result derivation (in line 20). Algorithm 1 obtains, as input values, the number of particles and four speed values of position information in the previous time adjacent to the current positioning data. Also, a mobility state is derived as a result value. The algorithm is invoked and operates each time position information is input. It is possible to determine to be a ‘mobile’ state when the value of X that line 19 returns is equal to or larger (or smaller) than a certain value, and it is possible to determine to be a ‘stay’ state when it is smaller than (or exceeds) the certain value.

More particularly, it is possible to determine to which mobility state the line 20 in Algorithm 1 belongs to among two or more ‘mobility states’. In this case, the mobility states may be divided into a plurality of states that includes a stay state and mobile states according to one or more transports. In addition, the mobile states according to the one or more transports may be a concept that includes a mobile state by walking, a mobile state by a bicycle, a mobile state by a vehicle, and a mobile state by a high-speed train. In addition, determining which state the mobility state indicates among the plurality of states may be performed by the comparison of the average value of N particles updated with one or more predetermined critical values.

The operation of Algorithm 1 is as follows:

Step 1) The current speed Vₜ is found by using position information at the current time by using Haversine formula (in line 2),

Step 2) Time weighted speed T is calculated by using Equation 1 (in line 4),

Step 3) N particles Particle[N] are generated and initialized (in line 6),

Step 4) Weight is found by using Equations 2 and 3 below (in line 9),

Step 5) The values of N particles (i.e., probabilities) are updated (in lines 10 to 14),

Step 6) Steps 4 and 5 above are repeated according to a condition (in line 7), and

Step 7) The average of particles (average value of probabilities) is found (in line 18), and the final mobility state is determined (in line 19).

Pₜ=1−e^{(-λ*T)} [Equation 2]

f(Particle[k],T)=Particle[k]−Pₜ/C [Equation 3]

The reason why the process of updating N particles by using a while loop in (line 7 of) Algorithm 1 are performed many times is that it is desired that the probability of particles becomes stable without a great change. Thus, it is possible to repeat the process by the constant number of times. Also, since a value that each particle has is a probability, it is possible to adjust the value to be within a section of 0 to 1 when the value becomes a negative number in the update process. For example, it is possible to change the value to 0 when the value becomes a negative number in the update process.

It is possible to apply, to a time weighted speed expression, a total of five speed values, the current speed value calculated by using Haversine formula and four speed values used for determining a mobility state of position information in the previous time, according to a time sequence. Thus, the window size of the time weight speed is 5 in the present embodiment. In this case, since five speed values of information at the current time and in the previous time are used, it is possible to perform state determination by using only the speed of the current position information without applying to the time weighted speed until five speed values are gathered. Thus, information input from the first time to the fourth time while position information is input may perform state determination by using the current speed. Also, when a test is actually performed, it is possible to separately store five speed values with the latest speed value whenever position information next time is input.

When a weight is found, a result of a study that the distribution of a human's speed follows an exponential distribution is used in order to express T, a certain speed value by a probability. Such a study result may be found in Paper 5 below. When it is possible to use other distribution as the human's speed distribution, it is also possible to modify the present disclosure by using such distribution.

### [Paper 5]

H. Y. Song and J. S. Lee, “Finding probability distributions of human speeds,” in AMBIENT 2014, The Fourth International Conference on Ambient Computing, Applications, Services and Technologies, 2014, pp. 51.55.

Since the T value is also a value obtained by using speed values, it may be considered to be a kind of a seed. Thus, it is possible to apply the T value to the exponential distribution. Thus, it is possible to use a probability Pₜ that a speed obtained through the exponential distribution when calculating a weight is T. It is possible to find the Pₜ value by using the cumulative distribution function of the exponential distribution in order to allow the probability Pₜ to have a larger value as the speed is quick. How to find Pₜ is presented in Equation 2.

Expression used when Algorithm 1 finds a weight is the same as Equation 3 above.

Firstly, the T value in Equation 2 is applied to the cumulative distribution function of the exponential probability distribution to find Pₜ. In this case, λ is provided with reference to a result value in Paper 3, and may be determined to be a constant value of 0.15949. The meaning of λ=0.15949 is that in the distribution of the speed, average and standard deviation are about 6.27 m/s.

Next, Pₜ may be applied to Equation 3 to find a weight. In Equation 3, C is a constant to decrease the Pₜ value in order to prevent the Pₜ value from becoming too large and thus the weight from becoming a negative number.

Lastly, the final mobility state determination may determine by using the average X of the probability of particles whether there is a stay state or mobile state. This may be determined by a comparison with a specific constant probability by using a simple conditional statement. The constant value is a value of 0 to 1, and may be determined to be a value that is considered to be appropriate through a test.

A test has been performed by using Algorithm 1.

The test includes collecting position information, calculating a speed by using the position information, applying the speed value to a time weighted speed, inputting the speed value obtained through the time weighted speed to a particle filter algorithm, deriving a result of mobility state determination, showing a result of test on a map, and expressing the result of test by a graph.
Collecting position information: The position information used in the test is collected by using a position information acquisition application installed in a smart phone. In addition, time, latitude, and longitude values are extracted form the position information and used as the input values of the test.
Calculating speed by using position information and Haversine formula: It is possible to calculate the distance between two points by using two pieces of position information and it is possible to calculate a speed. In this case, since time, latitude, and longitude information input at first time includes only information on a single point, it may be difficult to calculate a speed. Thus, determination on the position information input at first time is deferred and second information is input. Then, the speed and state of the second position are found and the same speed and state are also input to the first position. The reason is that the time difference when the first and second positions are written is shorter than or equal to several seconds and thus there is little probability that a change in state occurs within a short time. Thus, the speeds of pieces of position information subsequently input excluding the first position information are found by using Haversine formula.

In this case, in order to find the time weighted speed T by using Equation 1, there is a need to find an appropriate a that has highest accuracy. To this end, accuracy is found increasing the a value from 0 to 1 by 0.1. As a result of determination on the mobility states of a total of 3,371,577 pieces of position information, the accuracy varies according to the constant α. In this case, when the a is 0.3, results of 2,231,090 pieces of position information are correct and the accuracy is the highest, and it may be seen that the accuracy increases with an increase from 0.0 in α and then decreases from 0.3. Also, it may be seen that the accuracy surely decreases when the constant α has a value of 1.0. The mobility state of the current position information by using only Vₜ₋₄ has been determined and it may be seen that there is a low relationship between the speed values of the current state and the fourth previous time. Thus, the α value when the accuracy is the highest is found increasing α between 0.2 and 0.4 by 0.01.

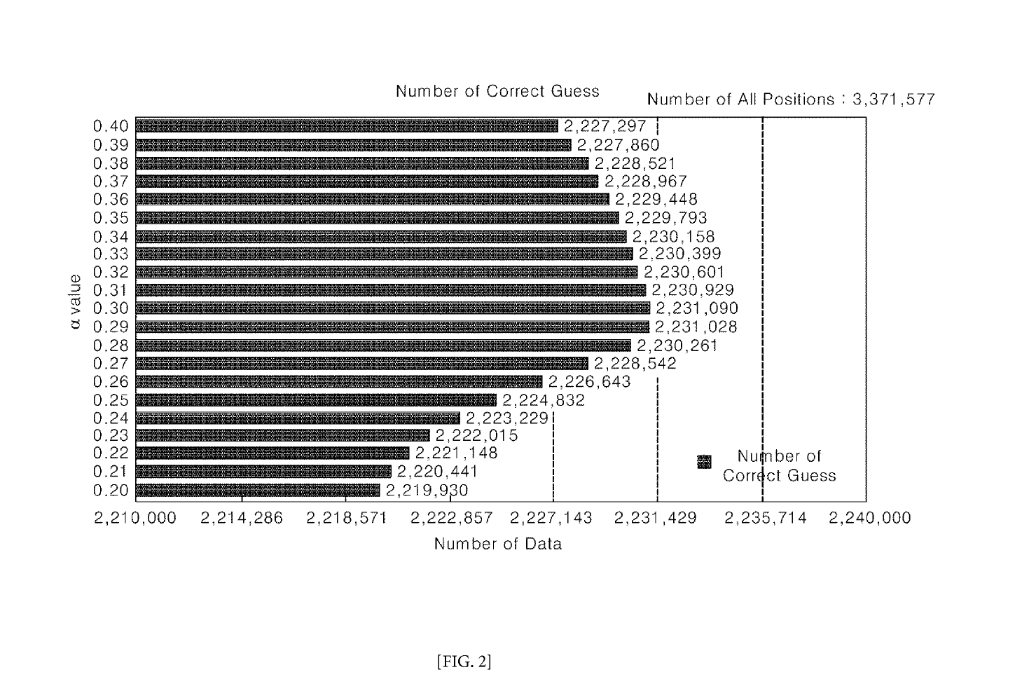

FIG. 2 is a graph of an a value according to the number of positioning information according to a second embodiment of the present disclosure. In this case, the X-axis represents the number of position information estimated that mobility state classification is correct, and the Y-axis represents the α value used in a time weighted speed expression. It may be seen that the accuracy is the highest when α is 0.3.

In this case, the accuracy of a test result may be recognized from the speed of position information. The reason is that fundamentally, the speed of 0 represents stay and other cases represents mobile. Thus, it is possible to represent the accuracy of mobility state determination of the entire information by counting the number of pieces of information when information the speed of which is calculated as 0 is determined to be stay and information the speed of which is greater than 0 is determined to be mobile.

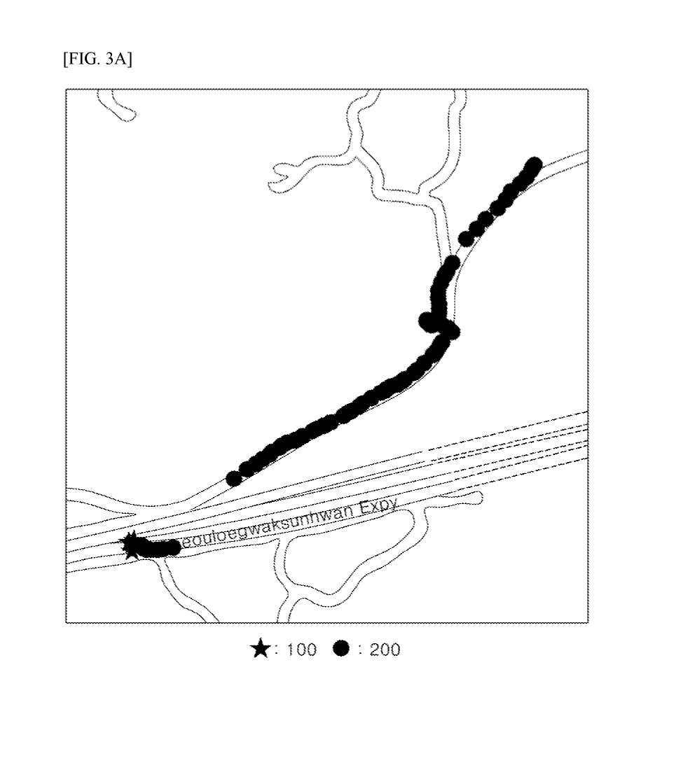

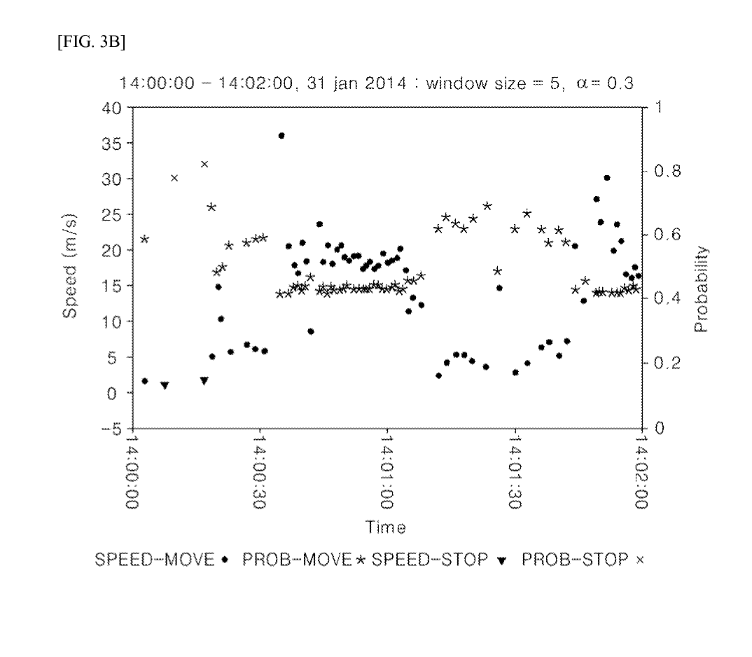

FIG. 3A is a diagram representing position information on vehicle mobility on a map according to the second embodiment of the present disclosure. In FIG. 3A, place marks are provided by using latitude and longitude information to be capable of recognizing mobile and stay states on the map. In this case, the stay state is represented by star place marks 100 and the mobile state is represented by circle place marks 200. Each place mark shows position information that includes latitude and longitude written according to a time. In this case, a window size is 5 and the constant α value is 0.3.

FIG. 3A represents data obtained in a time section from 14:00:00 to 14:02:00 on Jan. 31, 2014.

FIG. 3B is a speed-probability graph for vehicle's position information according to the second embodiment of the present disclosure. It shows the average of the probabilities of particles of position information at each time point and a speed at each point. In graph, the X-axis represents a time, the left Y-axis represents a speed (m/s) and the right Y-axis represents a probability. The graph allows stay and mobile states to be recognized by providing different marks for the position information determined to be the mobile state and the stay state in FIG. 3A. Thus, marks showing speeds are also differently marked according to a state. The mark means the speed value of position information determined to be a mobile state and the mark * means the average of the probabilities of particles of position information determined to be mobile. The mark x denotes the average of the probabilities of particles of position information determined to be a stay state and the inverted triangle mark represents the speed of position information determined to be stay.

In FIG. 3B, it may be seen that all probabilities are mostly distributed between 0.4 and 1.0. The reason is that the initial average of particles is provided as 0.5 through initialization, and when the speed is high, a weight increases, and the process of making 0 is performed when smaller than 0 in the process of updating the probability of a particle by using the weight. Thus, though the speed is high, the average value may not significantly fall from 0.5.

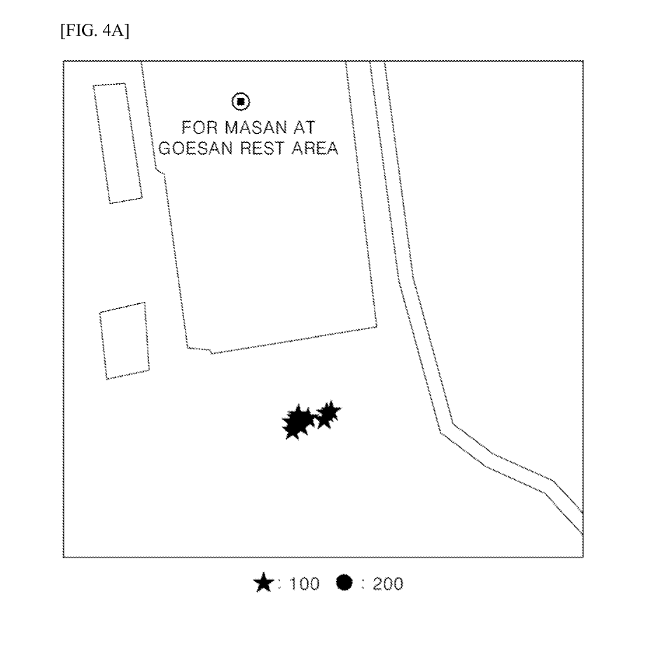

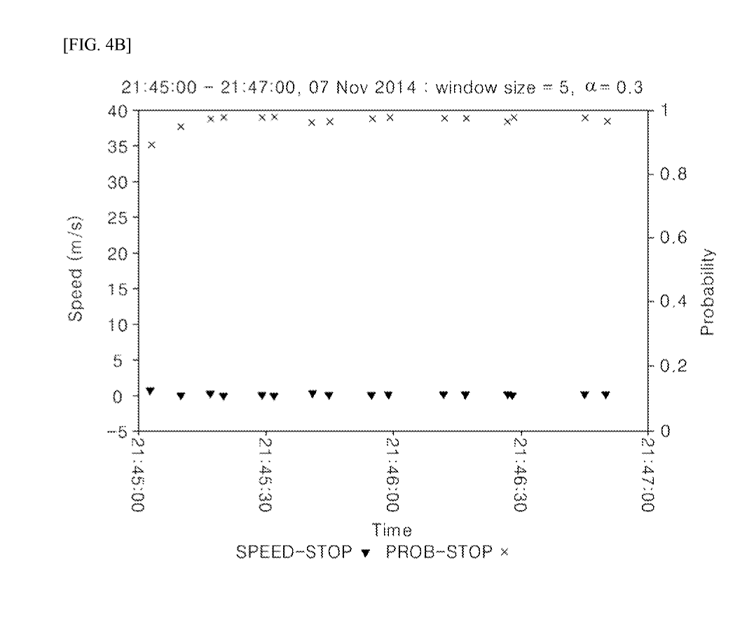

FIG. 4A is a diagram representing position information staying at an express way rest area on a map according to the second embodiment of the present disclosure. The widow size, a value, test time, and place mark information of FIG. 4A may be the same as those of FIG. 3A. FIG. 4A represents data obtained in a time section from 21:45:00 to 21:47:00 on Nov. 7, 2014.

FIG. 4B is a speed-probability graph for position information staying at the express way rest area according to the second embodiment of the present disclosure. In FIG. 4B, the X-axis, Y-axis, and mark information of the graph may be the same as those of FIG. 3B. As could be seen from the graph, speed values are all close to 0 and it may be considered to be an accurate result that is all determined to be stay.

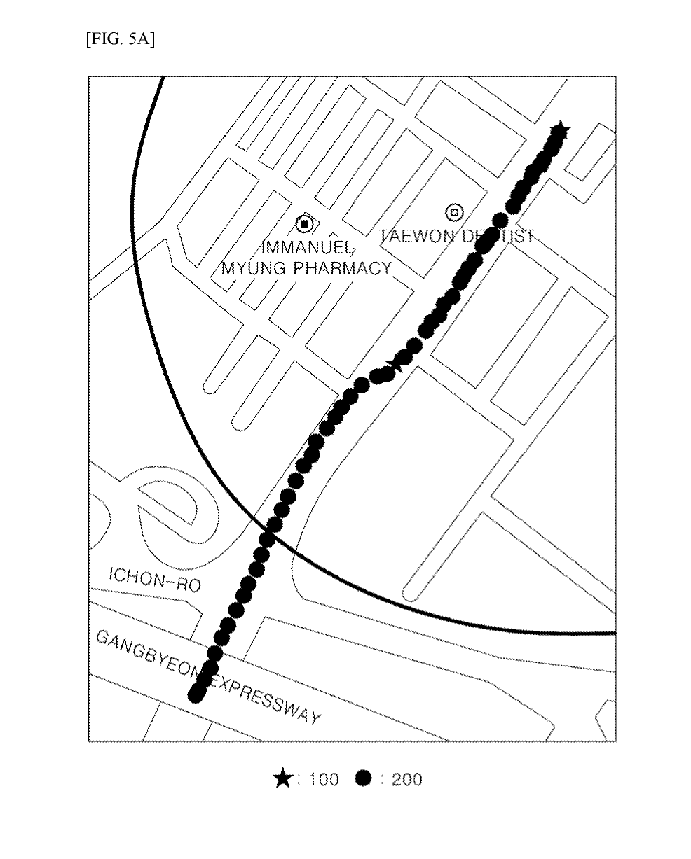

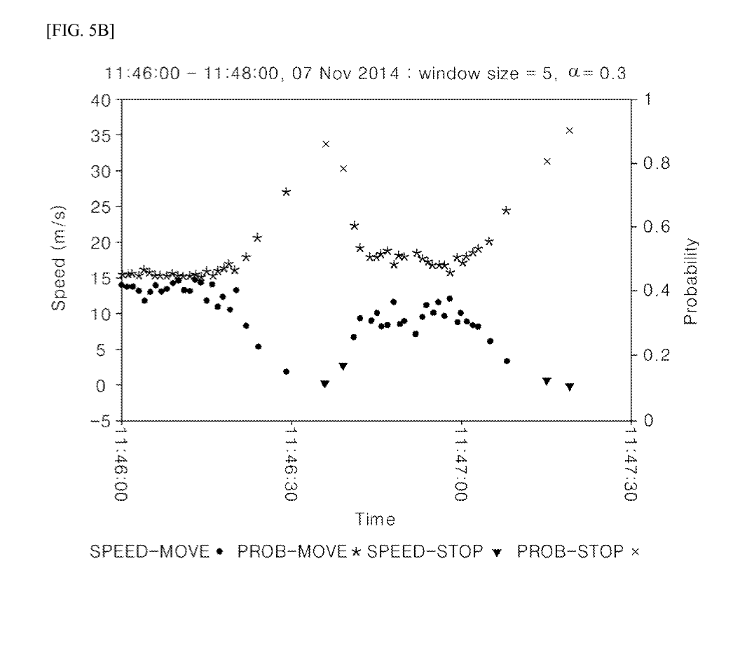

FIG. 5A is a diagram representing position information on vehicle mobility on a map according to the second embodiment of the present disclosure. The widow size, α value, test time, and place mark information of FIG. 5A may be the same as those of FIG. 3A.

FIG. 5A represents data obtained in a time section from 11:46:00 to 11:48:00 on Nov. 7, 2014.

FIG. 5B is a speed-probability graph for position information on vehicle mobility according to the second embodiment of the present disclosure. In FIG. 5B, the X-axis, Y-axis, and mark information of the graph may be the same as those of FIG. 3B. As could be seen from the graph, when position information determined to be stay is a criteria, the speed in the previous time tends to decrease and the speed in the later time tends to increase, so it may be considered to a typical type of stay when a vehicle moves.

In the present disclosure, the reason why state determination is performed by using a total of five speed values, the speed values of position information at a time to determine the current state and the four previous times is that there is a little difference between when the same test is performed by using six to nine speed value information and when the test is performed by five speed values. Also, the reason is that the speed of a time affecting the current speed is that of a too far time. The reason why there is the little difference in probability between when more position information is used and when five information is used is that the speed of a too far time needs to decrease a weight, so in the process of finding a time weighted speed value, a value smaller than 1 is continuously multiplied, becomes a significantly small value, and thus has a little effect on a speed calculation value to be used for final state determination.

### Third Embodiment

The third embodiment of the present disclosure extracts GPS data obtained by using the application program Sportstracker installed in a smart phone and uses the extracted data as an input value of a test. The test is performed by using daily data. It is possible to obtain the GPS data by using other methods.

Algorithm 2 to which a particle filter used in the present embodiment is applied is provided below:

[Algorithm 2]

01: Algorithm Particlefilter(N, Z)
02: // Initialize Particles
03: Particle[N]
04: while(condition)
05: for k=0 to N−1
06: //weight update
07: W = f(Particle[k], Z);
08: //particle update
09: If conditions then
10: Particle[k] = Particle[k] − W
11: Else
12: Particle[k] = Particle[k] + W
13: endif
14: end for
15: end while
16: //calculate X, return X
17: X = Average(Particle[N])
18: return X
19: end Particlefilter

Algorithm 2 uses the fundamental algorithm of the particle filter and includes particle generation and initialization, weight and particle updates, repetition, and result derivation. In Algorithm 2, the current speed value is marked as Z, not Vₜ. In Algorithm 2, the fact that the current speed value Z itself is used is different from Algorithm 1.

It is possible to assign a probability between 0 and 1 so that particles may have different values through initialization.

Time, latitude, and longitude information input at first time need to calculate a speed by calculating a distance between two points but since there is only information on one point, it is difficult to calculate the speed. Thus, determination on the information input at first is held, the speed and state of a second position are found after second information is input, and it is also possible to apply the same speed and state to first position information. The reason is that the time difference between first and second inputs is shorter than or equal to several seconds and thus there is a little probability that a change in state occurs within a short time. Also, the speed after second GPS information may be found by using Haversine formula.

According to Algorithm 2, the processes of first generating N particles (in line 3), finding a weight W by using the speed Z being a measurement value (in line 7), and updating the probabilities of particles (in line 8) are performed.

When the weight W is found, the study result of Paper 6 below saying that the distribution of a human's speed follows exponential distribution is used in order to express the speed Z by a probability.

### [Paper 6]

J. S. Lee and H. Y. Song, “Distribution estimation of human speeds”, 2014 spring conference of KIPS, Vol. 21, No. 1, 2014.

That is, when a weight is calculated, the speed Z is not used and a probability P_z that the speed obtained through exponential distribution is Z is used. In order for probability P_z to have a higher value with an increase in speed, it is possible to find P_z value by using the cumulative distribution function of the exponential distribution.

The expression f (Particle[k], Z) means the simple expression of four fundamental rules of arithmetics and a constant multiplication using a probability obtained by using a particle value and a speed.

According to a human mobility state determination method according to a third embodiment of the present disclosure, the final state determination on whether there is a stay state or mobile state may be performed on by using the average of the probabilities of particles of corresponding data (in line 17).

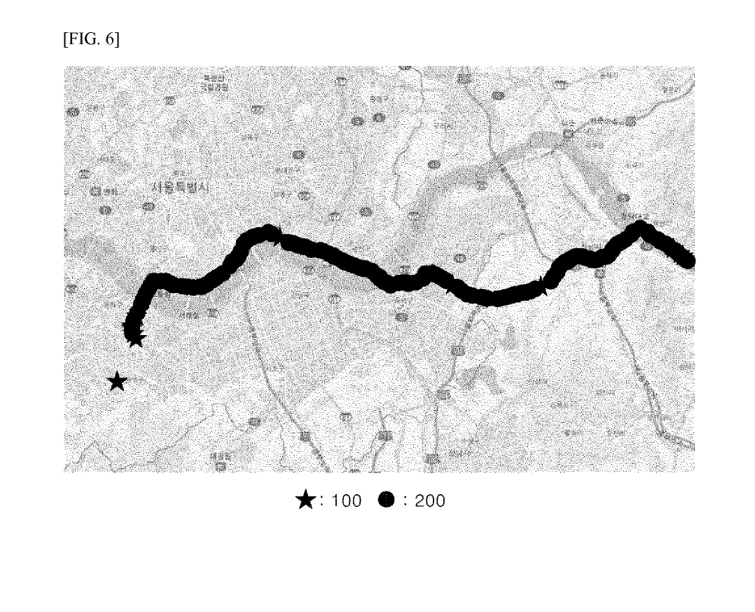

FIG. 6 shows stay and mobile states on a map by using a kml viewer. The stay state is represented by star place marks 100 and the mobile state is represented by circle place marks 200. The place mark shows, one by one, data including latitude and longitude written according to a time that is obtained through the Sportstracker.

FIG. 6 is data obtained while a human starts from a first place (e.g., Gwanak-gu, Seoul), stays at a second place (e.g., Songpa-gu, Seoul) for a certain time, then moves to a third place (e.g., Hanam-city, Kyoungi-do), and moves back to the second place.

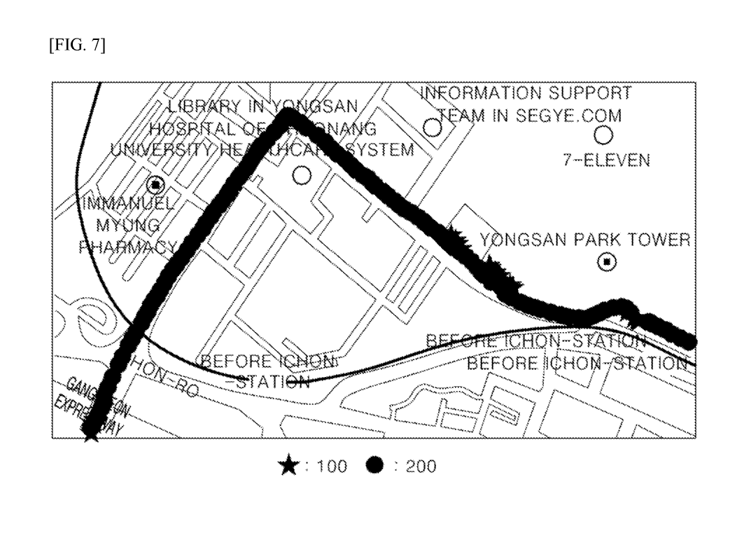

FIG. 7 divides data on a section enabling easy movement without traffic jam into mobile and stay states. In FIG. 7, it may be seen that there are many mobile states and a few stay states.

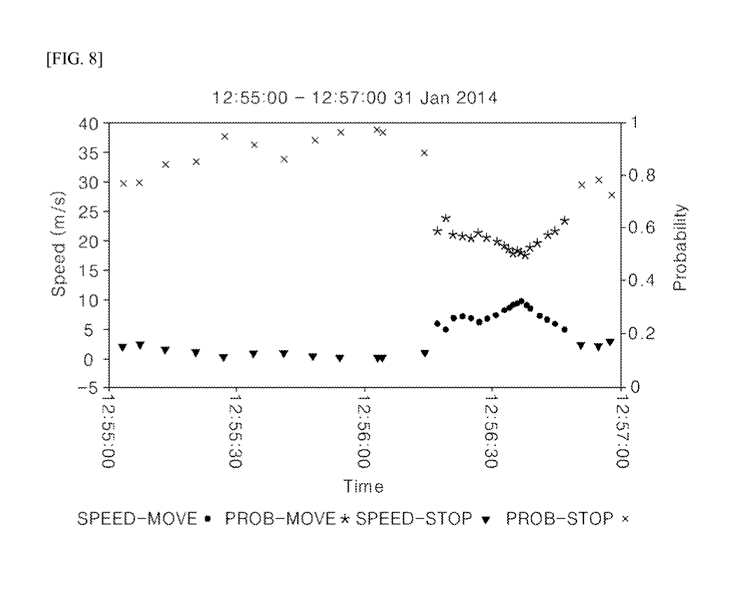

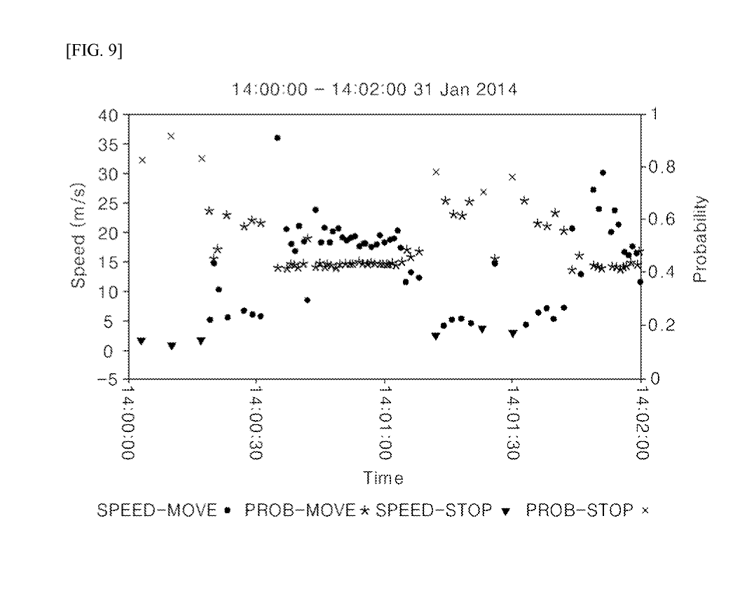

FIGS. 8 and 9 are graphs of a speed upon stay and mobile at a specific time and a probability obtained from a particle filter in the entire data in FIG. 7. Each figure shows data for two minutes. FIG. 8 is data obtained in a time section from 12:55:00 to 12:57:00, on Jan. 31, 2014, and FIG. 9 is data obtained in a time section from 14:00:00 to 14:02:00, on Jan. 31, 2014.

Referring to FIG. 8, it may be seen that positioning data determined to be in the stay state is maintained for a certain time. The mobile state is also similar thereto. It is determined to be a correct result because there is a little possibility that after the mobile state of a human changes from stay to mobile within a short time, this state changes to the stay without maintaining the mobile state. Since a particle filter has reflected a speed and a value obtained by using exponential distribution to a weight, it may be seen from the relationship between the speed and the probability that a slow speed involves a high probability from the fact that the speed of the stay state is lower than that of the mobile state but the probability is high. The speed of the stay state is distributed to be lower than or equal to 5 m/s and the speed of the mobile state is shown with various values. Also, when the state changes from the stay to the mobile, the speed of the mobile state shows rising distribution and when the state changes from the stay to the mobile, the speed shows falling distribution.

Referring to FIGS. 8 and 9, it may be seen that probabilities are distributed between 0.4 to 1. It may be seen that the probability of the mobile state is mostly located near 0.4 and the probability of the stay state is relatively close to 1.0.

Referring to FIG. 9, it may be seen that there is a single mobile state between stay states near 14:01:30. It is determined to be a result by the sudden rise of the speed. Also, it may also be seen that there is a single stay state between mobile states.

Since a speed value is inaccurate when the latitude and longitude of GPS data are marked on a wrong position, the effect of an inaccurate speed value on a weight should be decrease when the weight is calculated. Thus, when Xt is found for error determination, it is possible to find a more accurate result by checking a surrounding speed moving like window, by using five surrounding positioning data as well as the speed value. An embodiment to which such an idea is reflected is the above-described embodiment 2.

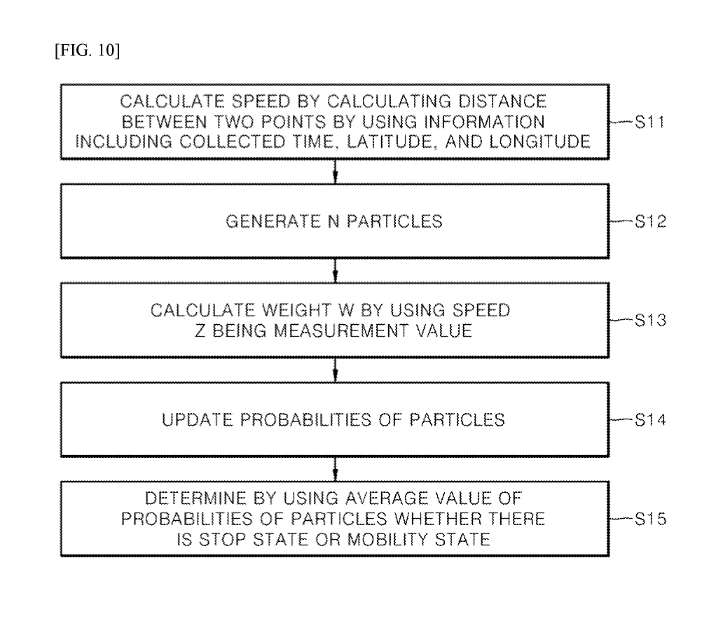

FIG. 10 is a flowchart of a determination method of mobility using a computer according to a third embodiment of the present disclosure.

In step S11, a speed Z is calculated by the calculating of the distance between two points by using information that includes a collected time, latitude and longitude.

In step S12, N particles are generated.

In step S13, a weight W is found by using the speed Z being a measurement value.

In step S14, the probabilities of the particles are updated.

In step S15, it is determined by sing the average of the probabilities of the particles whether there is a stay state or mobile state.

### Fourth Embodiment

The fourth embodiment is a modification to the above-described second embodiment. An algorithm to which a particle filter used in the present embodiment is applied is provided in Algorithm 3 below:

[Algorithm 3] - Mobility State Classification with Particle filter

| 01: procedure | |
|---|---|
| 02: Classification(N, Vₜ₋₁, Vₜ₋₂, Vₜ₋₃, Vₜ₋₄) | |
| 03: Obtain new position | |
| 04: Calculate Vₜ | |
| 05: // Calculate current speed by harversine formula | |
| 06: Calculate T | |
| 07: // Calculate Time-Weighted Speeds by equation (1) | |
| 08: Particle[N] // Declare and Initialize Particles | |
| 09: for i=0 to 4 do | |
| 10: for k=0 to N−1 do | // For N Particles |

| 11: W = f(Particle[k], T);//weight update | |
|---|---|
| 12: If conditions then | |
| 13: Particle[k] = Particle[k] − W | |
| 14: Else | |
| 15: Particle[k] = Particle[k] + W | |
| 16: endif | //particle update |

| 17: end for | |
|---|---|
| 18: end for | |
| 19: X = Average(Particle[N]) //calculate X | |
| 20: return X | |
| 21: | // Mobility State Classification |
| 22: end procedure | |

The operation of Algorithm 3 is as follows:

Step 1) The current speed Vₜ is found by using position information at the current time by using Haversine formula (in line 4),

Step 2) A time weighted speed T is calculated by using Equation 1 (in line 6),

Step 3) N particles Particle[N] are generated and initialized (in line 8),

Step 4) A weight is found by using Equations 2 and 3 above (in line 11),

Step 5) The values of particles (i.e., probabilities) are updated (in lines 12 to 16),

Step 6) Steps 4 and 5 above are repeated in order to update the values of N particles (in line 10),

Step 7) A second ‘for’ loop (in line 10) is repeated five times (in line 9), and

Step 8) The average of particles (i.e., average value of probabilities) is found (in line 19), and the final mobility state is determined (in line 20).

The constant ‘5’ in Algorithm 3 is used in order to repeat the updates of N particles and the reason why such repetition is performed is for stabilizing the probability. On the contrary, general SIS algorithms update particle values only once.

In the step of generating and initializing N particles in Algorithm 3, the average value of particles may become 0.5.

The condition of the line 12 in Algorithm 3 corresponds to when the value of a corresponding particle is smaller than or equal to 0.5 and the weight is larger than 0.5, and when the value of particle is equal to or larger than 0.5 and the weight is smaller than 0.5. It is to make the value of a particle close to 0 or 1. When the weight of a particle having a value smaller than 0.5 is large, it is possible to subtract the weight to make the value of the particle close to 0 and when it is small, it is possible to add the weight of the particle to make the value of the particle close to 1. In addition, when the weight of a particle having a value larger than 0.5 is small, it is possible to subtract the weight to make the value of the particle close to 0 and when it is large, it is possible to add the weight to make the value of the particle close to 1. The above description is presented in Table 1 below.

TABLE 1

| Condition | Particle <= 0.5 | Particle > 0.5 |
|---|---|---|
| Weight <= 0.5 | line 15 (+) | line 13 (−) |
| Weight > 0.5 | line 13 (−) | line 15 (+) |

After the particle is updated and the operation is repeated, X, the mobility state is finally found by using the average of the probabilities of particles. For example, it is possible to determine to be mobile when the average value of the probabilities is smaller than a test value of 0.75, and to be stay when negative.

Other steps excluding the above description may be the same as those in Algorithm 1.

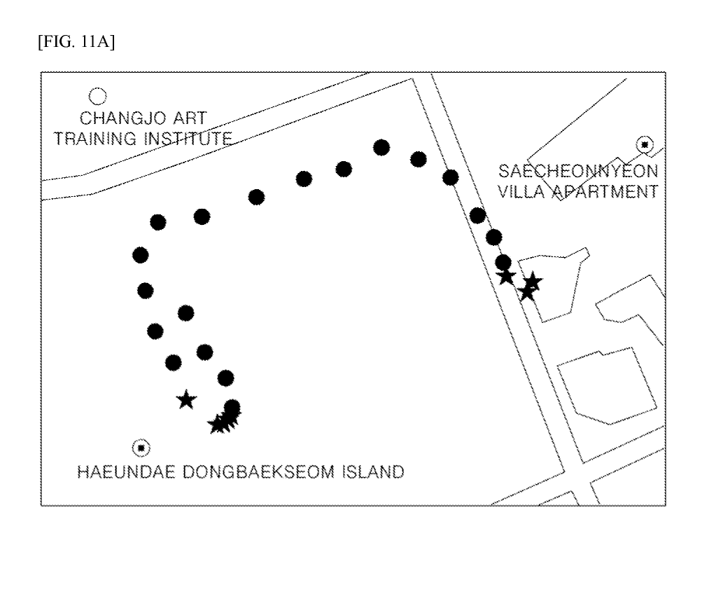

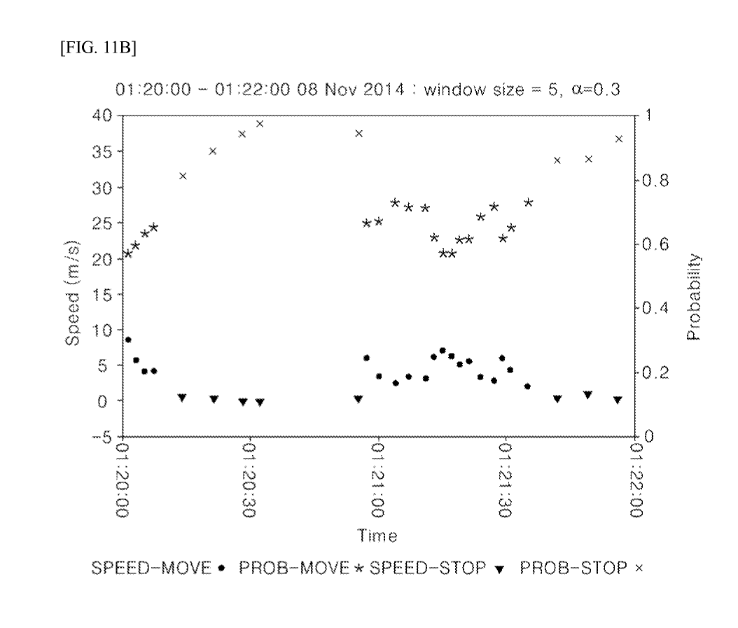

FIG. 11A is a diagram representing position information on vehicle mobility on a map according to a fourth embodiment of the present disclosure.

FIG. 11B is a speed-probability graph for vehicle's position information according to the second embodiment of the present disclosure.

While a portion of continuous data in FIG. 11B shows a low speed and a high stay probability, other portions show a high speed and a high mobile probability. It shows the stay and mobile situations of a typical vehicle. Five result values near 01:20:03 of FIG. 11B are classified as stay, in which case the result value corresponds to the star place mark of the lower left portion of FIG. 11A. The portion of continuous data represents when a vehicle does a U-turn, has a relatively low speed value, and has a big time difference. It may be seen that the vehicle is accelerated near 01:20:53.

### Fifth Embodiment

The fifth embodiment is a modification to the above-described third embodiment. An algorithm to which a particle filter used in the present embodiment is applied is provided in Algorithm 4 below:

[Algorithm 4]

01: Algorithm Particlefilter(N, Z_{avg})
02: // Initialize Particles
03: Particle[N]
04: while(condition)
05: for k=0 to N−1
06: //weight update
07: W = f(Particle[k], Z_{avg});
08: //particle update
09: If(condition)
10: Particle[k] = Particle[k] − W
11: Else
12: Particle[k] = Particle[k] + W
13: endif
14: end for
15: end while
16: //calculate X, return X
17: X = Average(Particle[N])
18: return X
19: end Particlefilter

Algorithm 4 is a variation to Algorithm 2. There is a difference in that the input value of Algorithm 2 is the number N of particles and the current speed Z but the input value of Algorithm 4 is the number of particles and an average speed Z_{avg}. For example, the average speed means the average of the speed value of the current positioning data and the speed values of the four previous times. That, it means the average of a total of five speed values. It is used to supplement that an inaccurate mobility state may be derived when an inaccurate speed value is obtained due to an error in positioning data. Thus, when determining the mobility state of the current positioning data, it is also possible to reflect the speed values of the previous data as well as the current speed. In this case, data before five speed vales are collected is not input to the second input value of a particle filter algorithm as an average speed, and the speed of the current positioning data may be input.

The condition of the line 9 in Algorithm 4 corresponds to when the value of a corresponding particle is smaller than or equal to 0.5 and the weight is larger than 0.5, and when the value of the particle is equal to or larger than 0.5 and the weight is smaller than 0.5. It is to make the value of the particle close to 0 or 1. When the weight of a particle having a value smaller than 0.5 is large, it is possible to subtract the weight to make the value of the particle close to 0 and when the weight is small, it is possible to add the weight of the particle to make the value of the particle close to 1. When the weight of a particle having a value larger than 0.5 is small, it is possible to subtract the weight to make the value of the particle close to 0 and when the weight is large, it is possible to add the weight to make the value of the particle close to 1. The above description is presented in Table 1.

After the particle is updated and the operation is repeated, X, the mobility state is finally found by using the average of the probabilities of particles. It is possible to determine to be mobility when the average value of the probabilities is smaller than a test value of 0.75, and to be stay when negative.

Other steps excluding the above descriptions may be the same as those in Algorithm 2.

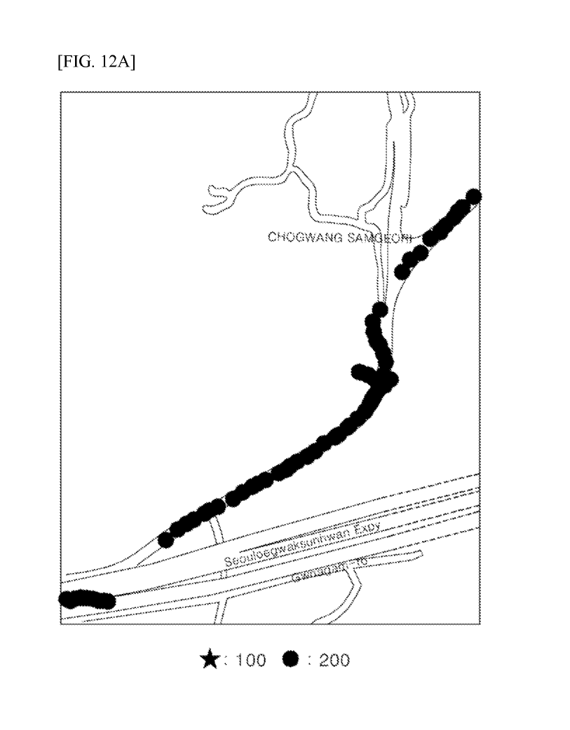

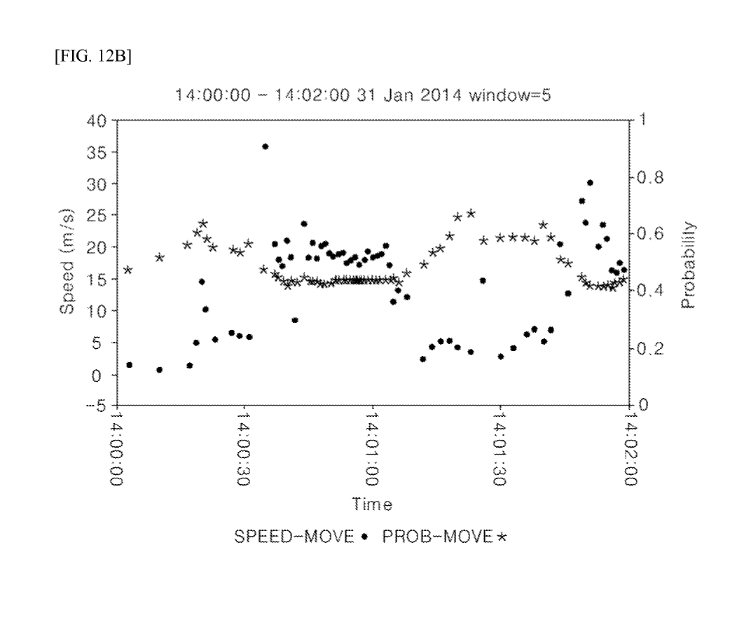

FIG. 12A is a diagram representing position information on vehicle mobility according to a fifth embodiment of the present disclosure.

FIG. 12B is a speed-probability graph for vehicle's position information according to the fifth embodiment of the present disclosure.

FIG. 12B represents a straight section corresponding to FIG. 12A by a speed-probability graph. Mark information used in FIGS. 12A and 12B may be the same as that of FIG. 3.

When comparing FIG. 9 with FIG. 12B, FIG. 9 uses only the current speed and FIG. 12B uses the average speed. While in FIG. 12B, it is determined that all data is mobile, in FIG. 9, there is data determined to be stay. In FIG. 12B, it may be seen that a problem that a state continues to change within a short time has been solved. Also, determining the first three data in FIG. 12B to be mobile may be due to the effect of the speed of the previous time because the average speed is used.

Although the present disclosure has been described by using embodiments obtaining positioning data by using a GPS device for the convenience of description, it may be understood that it is possible to apply position information obtained by using other types of positioning devices or systems excluding the GPS to various embodiments according to the above-described present disclosure.

According to the present disclosure, it is possible to accurately analyze the mobility state of positioning data by using a particle filter.

A person skilled in the art to which the present disclosure pertains may easily implement various variations and modifications without departing from the essential characteristic of the present invention, by using the above-described embodiments of the present disclosure. The details of each claim in the following claims may be combined with other claims not dependent thereon as long as it is possible to understand through the specification.

What is claimed is:

1. A method of determining a mobility state of a specific target by using a particle filter having N particles defined as N independent random variables, the method comprising:
calculating a current speed of the specific target, and calculating a value relating to a cumulative probability at which the specific target has the current speed;
repeating a particle update process of updating values of the N particles by a predetermined number of times; and
after the repeating, calculating an average value of the updated N particles, and determining a mobility state of the specific target based on the average value,
wherein a weight used for updating the value of the N particles is calculated by using the cumulative probability.

2. The method of claim 1, wherein
the particle update process comprises:
subtracting the value relating to the cumulative probability from the value of each of the N particles to calculate the weight; and
subtracting the weight from the value of each of the N particles or adding the weight to the value of each of the N particles to update the values of the N particles.

3. The method of claim 1, wherein
the current speed is one of:
a time weighted-speed T at a first time point obtained by multiplying one or more speed values detected at and before the first time point for the specific target by predetermined weights, respectively, and adding values obtained through the multiplication,
a speed value detected at the first time point for the specific target, and
an average value of one or more speed values detected at and before the first time point for the specific target.

4. The method of claim 3, wherein,
when the current speed is the a time weighted-speed T,
a first weight multiplied to a first speed value is larger than a second weight multiplied to a second speed value, if the time at which the first speed value is detected is closer to the first time point than the time at which the second speed value is detected.

5. The method of claim 1, wherein
the mobility state is classified into a plurality of states comprising a stay state and a mobile state, and
determining to which a state belongs among the plurality of states is performed by comparing, an average value of the N particles, with one or more predetermined critical values.

6. A mobility state determination method comprising:
initializing a particle filter that has, as particles, N independent random variables having a value of 0 to 1;
repeating a particle update process by a predetermined number of time; and
after repeating, calculating an average value of updated N particles, and determining a mobility state of the specific target by using the average value;
wherein a current speed of the specific target at a first time point is used as a new observation value for inputting to the particle filter.

7. The mobility state determination method of claim 6,
wherein the particle update process comprises:
obtaining the current speed;
updating a likelihood probability at which the specific target has the current speed, based on current values that the N particles have;
obtaining a weight by using the updated likelihood probability; and
updating the N particles by using the weight.

8. The mobility state determination method of claim 7, wherein a value of a certain particle of the N particles is set to 0 when the value of the certain particle becomes a negative value by the updating of the N particles.

9. The mobility state determination method of claim 7, wherein the likelihood probability is calculated by using a cumulative distribution function of exponential distribution.

10. The mobility state determination method of claim 6,
wherein the current speed is one of:
the speed value detected at the first time point for the specific target,
an average value of one or more speed values detected at and before the first time point for the specific target, and
a time weighted-speed T at the first time point obtained by multiplying the one or more speed values detected at and before the first time point for the specific target by predetermined weights, respectively, and adding values obtained through the multiplication.

11. The mobility state determination method of claim 6, wherein
the mobility state is classified into a plurality of states comprising a stay state and mobile states according to one or more transports,
the mobile states according to the one or more transports comprise a mobile state by walking and a mobile state by a vehicle, and
determining to which a state belongs among the plurality of states is performed by comparing, an average value of the updated N particles, with one or more predetermined critical values.

12. A mobility state determination device comprising a processing unit that determines a mobility state of a specific target by using a particle filter having N particles defined as N independent random variables, wherein the processing unit is configured to:
calculate a current speed of the specific target, and calculate a value relating to a cumulative probability at which the specific target has the current speed;
repeat a particle update process of updating the N particles by a predetermined number of times; and
after the repeating, calculate an average value of the updated N particles, and determine a mobility state of the specific target based on the average value,
wherein a weight used for updating the value of the N particles is calculated by using the cumulative probability.
